(19) United States
(12) Patent Application Publication
(10) Pub. No.: US 2021/0201139 A1
(43) Pub. Date: Jul. 1, 2021

(54) DEVICE AND METHOD FOR MEASURING A CHARACTERISTIC OF AN INTERACTION BETWEEN A USER AND AN INTERACTION DEVICE

(71) Applicant: Hoomano, Lyon (FR)

(72) Inventors: Xavier Basset, Collonges Au Mont D'or (FR); Amélie Cordier, Villeurbanne (FR)

(21) Appl. No.: 17/058,495

(22) PCT Filed: May 24, 2019
(86) PCT No.: PCT/FR2019/051208

§ 371 Date: Nov. 24, 2020

(30) Foreign Application Priority Data
May 25, 2018 (FR) 1854432

(51) Int. Cl. G06N 3/08; G06N 3/04

(52) U.S. Cl. CPC G06N 3/08; G06N 3/0445

(57) ABSTRACT

A device and a method for measuring a predefined characteristic of an interaction capable of being present between an interaction device and a user comprises an input interface for receiving at least one temporal sequence of data representative of the interaction and a classification module, which is connected to the input interface and processes the temporal sequence of data to output a measure of the predefined characteristic. The classification module has been configured from temporal sequences of learning data marked with the presence or absence of the characteristic. Such a measuring device may be used for detecting the start and/or end of the interaction between the user and the interaction device.

### CROSS-REFERENCE TO RELATED APPLICATIONS

This application is a national phase entry under 35 U.S.C. § 371 of International Patent Application PCT/FR2019/051208, filed May 24, 2019, designating the United States of America and published as International Patent Publication WO 2019/224501 A1 on Nov. 28, 2019, which claims the benefit under Article 8 of the Patent Cooperation Treaty to French Patent Application Serial No. 1854432, filed May 25, 2018.

### TECHNICAL FIELD

The present disclosure relates to a device for measuring a predefined characteristic associated with an exchange of information between an interaction device and a user. It finds its application, in particular, in the field of interaction devices such as smart screens, connected speakers or even “social” robots or any other form of connected object, to improve the quality of social interactions likely to develop between a user and such an interaction device.

### BACKGROUND

Very generally, an interaction is defined as an exchange of information between at least two different agents. A “social” interaction is an interaction where at least one of the agents is a human user. It can thus be an interaction between a user and an interaction device.

In the context of the present description, the term “interaction device” will denote a computerized device provided with information acquisition means, a processing unit for processing the acquired information, as well as transmission, information return or activation means. The combination of these means allows the device to interact with a user. Interaction devices can take many forms. It can therefore be a telephone, a computer, a connected speaker, a “smart display” or even a robot, for example, a social robot. It may also be a fully distributed device, such as a home automation system integrated into a building, equipped with means of interface with its users.

The information exchanged between the user and the interaction device can also take very various forms. As far as the user is concerned, this may be very explicit instructions in verbal form, in the form of an action such as that corresponding to pointing an object with a finger on a touchscreen or requesting an interface such as a keyboard. The interaction device can, by way of example, explicitly provide information to the user verbally, by voice synthesis, or by displaying a text or image on a screen, by activating a device in his environment. Some of the information exchanged during an interaction may also be less explicit: it may be an attitude or a position held by the user or by the device, the intonation of the voice or a facial expression.

In order to be sensitive to explicit or implicit information expressed by the user, the interaction device is equipped with input devices, such as sensors, capable of measuring a variety of parameters. It may be, for example, a touchscreen, an optical sensor such as an image sensor, or else an acoustic sensor such as a microphone.

The term “context of an interaction” will denote all the data collected by the input-output devices of the interaction device aimed at characterizing the exchange of information, which is likely to be present between a user and the user device itself. The interaction context also includes the state variables of the interaction device itself.

The context of an interaction is usually processed by the processing unit of the interaction device in order to interpret the user's behavior. For example, an acoustic sensor can communicate an audio signal to the processing unit that the latter will analyze in order, for example, to detect a key word or a key phrase indicating the user's intention to initiate an interaction.

The transmission, information return or activation means allow the interaction device to interact with the user. It can be, for example, information transmitted visually by means of a screen or by a movement of a part of the interaction device, or else transmitted acoustically by means of a loudspeaker. It can also be a combination of several of these means.

The possible interactions with these devices have diversified and become more complex thanks to the emergence of a wide variety of sensors, the wealth of information that can be analyzed, and the increase in processing capacities.

This development was notably caused by the desire to make interactions between users and interaction devices as instinctive as possible, and close to the interaction that can take place between two human agents. This is most particularly the case when the interaction device is an interaction robot. In the latter case, progress has been made to make these “social” robots, i.e., capable of naturally interacting with a user.

Work has thus been carried out to make the behavior of a robot more natural and human during an interaction, while it is generally programmed in advance to initiate a series of specific actions in response to the analysis of the information provided by the sensors.

By way of illustration, document US20120116584 discloses a robot having a set of preprogrammed behavior models, from which is chosen, according to the information provided by its sensors, the model corresponding to the most suitable behavior.

Also known from document U.S. Pat. No. 9,724,824 is a robot, which restricts the list of its next actions to a list of possible actions for a given user, according to the result obtained at the end of its previous actions.

Generally, the sensors found in this type of robot are configured to detect the occurrence of short-duration events directly related to the user, such as a facial emotion (smile, frown, yawn, etc.), a brief movement (crossing your arms, turning your head, etc.), the utterance of a keyword (“Ok, Google”, “Hey, Siri” etc.), a contact (pressing a specific activation button of the interaction device). This is particularly the case with the conversation simulator described in document WO200237249. This simulator includes a module programmed to process video images and provide information on the content of these images: the number of people in the field of vision, the user's identity, the user's dormant or lying state or who gets up. The function of this module is to process the image or video images in order to detect therein, in its content, characteristics of the user himself, and not on the interaction that he has with the device.

Although these known techniques can help make the relationship established between a user and an interaction device more natural, the sequence of “event detection—action” sequences by the interaction device remains very mechanical. And these known approaches do not therefore generally allow on their own the interaction device to initiate or interrupt an interaction with a user on its own initiative, i.e., without having been expressly instructed by the user.

The present disclosure aims to address this problem, at least in part. More generally, the present disclosure aims to establish social interactions between an interaction device and a user, which appear more natural to the user than in the solutions of the state of the art.

### BRIEF SUMMARY

With a view to achieving one of these aims, the purpose of the present disclosure proposes a device for measuring a predefined characteristic of an interaction likely to be present between an interaction device and a user, wherein the measuring device comprises an input interface connected to the interaction device and to an image sensor or sound sensor originating from an interaction zone in which the user is likely to be and thus receive data representative of the interaction and a classification module connected to the input interface processing:
a temporal sequence of the image or sound data of the interaction zone;
a temporal sequence of at least one state variable of the device;

to establish at output a measurement of the predefined characteristic, the classification module having been configured on the basis of temporal sequences of training data marked with the presence or absence of the characteristic.

According to other advantageous and non-limiting features of the present disclosure, taken alone or in any technically feasible combination:
the predefined characteristic can take a predetermined number of states and the device comprises an interpretation module receiving as input the measurement of the predefined characteristic and processing the measurement to generate at output an event marking the change of state of the characteristic;
the classification module comprises a recurrent neural network;
the input interface is connected to an image sensor of an interaction zone in which the user is likely to be located, and the temporal sequence of data comprises an image temporal sequence of the zone of interaction;
the interpretation module is also connected to the input interface;
the predefined characteristic is the user's attention;
the predefined characteristic is the user's interaction with the interaction device;

The purpose of the present disclosure also proposes an interaction device comprising such a measuring device.

According to another aspect, the purpose of the present disclosure proposes a method for measuring a predefined characteristic of an interaction likely to be present between an interaction device and a user.

According to the present disclosure, the measurement method comprises the following steps:
receiving at least one state variable of the device and image or sound data representative of the interaction via an image or sound sensor originating from an interaction zone in which the user is likely to be located;
providing a temporal sequence of the state variable and image or sound data to a classification module configured from temporal sequences of training data marked by the presence or absence of the characteristic;
processing the temporal sequence by the classification module to establish a measurement of the predefined characteristic.

According to other advantageous and non-limiting features of the present disclosure, taken alone or in any technically feasible combination:
the predefined characteristic can take a determined number of states, the method comprising:
   providing the measurement of the predefined characteristic to an interpretation module;
   processing the measurement by the interpretation module to generate an event marking the change of state of the characteristic.
the processing is performed on a computing device separate from the interaction device.

According to yet another aspect, the purpose of the present disclosure proposes an interaction device comprising such a measuring device and the use of the measuring device to detect the start and/or end of the exchange of information between the user and the interaction device.

According to a last aspect, the purpose of the present disclosure proposes a method of sequencing an interaction between a user and an interaction device. This sequencing process comprises the following steps:
receiving an event marking the change of state of a predefined characteristic of an interaction likely to be present between an interaction device and a user;
executing an interaction script chosen based on the nature of the event.

According to other advantageous and non-limiting features of the present disclosure, taken alone or in any technically feasible combination:
the event marking the change of state corresponds to the detection of the favorable start of an interaction and the interaction script is a script for initiating an exchange.
the event marking the change of state corresponds to the detection of the end of an interaction and the interaction script is an exchange termination script.

### BRIEF DESCRIPTION OF THE FIGURES

The present disclosure will be better understood in the light of the following description of a specific non-limiting embodiment of the present disclosure with reference to the attached figures, among which:

FIG. 1 schematically represents an interaction device;

FIG. 2 schematically represents a device for measuring a characteristic of the interaction context;

FIG. 3 schematically represents the operation of the measuring device according to a second embodiment;

FIG. 4 represents the general architecture of a measuring device in accordance with one embodiment

### DETAILED DESCRIPTION

The terms “interaction” and “information exchange” will be used interchangeably in the present application.

General Description of an Interaction Device

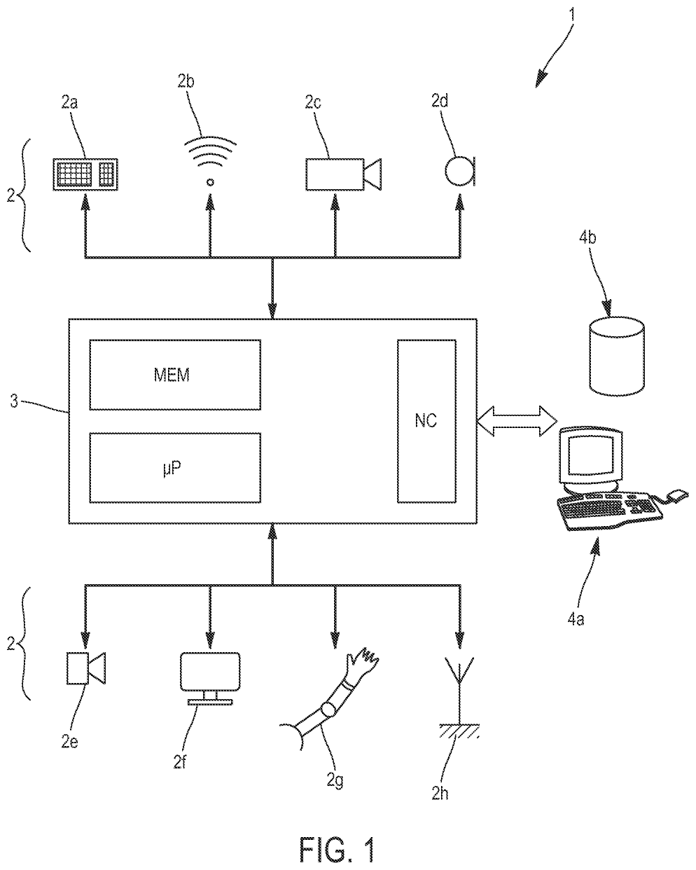

As shown in FIG. 1, an interaction device 1 in accordance with the present description typically comprises a plurality of information input-output devices 2 connected to a processing unit 3, for example, a processing unit 3 with uP microprocessor and MEM memory. The input-output devices 2 can take any form known per se: keyboard 2a or any other form of mechanical input means (such as switches, push buttons), image sensor 2c (RBG and/or infrared, for example), sonar 2b, microphone 2d to pick up an acoustic signal or a sound level, screen 2f (touchscreen or not), speaker 2e, etc. These input-output devices can also include activators or effectors 2g of the interaction device: manipulator arm, means for moving the interaction device itself or a part of it, activators or telecommunications device 2h aiming to activate a device in its environment, for example, to turn on or off a light, raise or lower a roller shutter, etc. The screen 2f, for example, a tablet type screen, can, in particular, be the medium of a graphical interface to represent an avatar of the interaction device, eyes or any animated form on the screen.

The interaction device 1 can take an integrated form in which at least part of the input-output devices 2 and of the processing unit 3 are assembled to form an identifiable object, such as a social or other robot, a screen or a connected speaker. Alternatively, it can take a distributed form in which at least some of these elements are arranged at a distance from each other, and connected to each other via a wired or other communication network and able to implement any standardized or other protocol. Whatever form the interaction device 1 takes, it has or is connected to an energy source, battery or electrical network, for example, to allow its operation.

Very generally, and in accordance with the approaches known from the state of the art, the interaction device collects information by means of its input-output devices 2, which are transmitted and processed by the processing unit 3 in order to determine the most appropriate interaction sequence, implemented by the appropriate input-output devices 2. To do this, and, in particular, when the processing of information requires significant computing power, the processing unit 3 can be in communication with an auxiliary computing device 4a or external storage means 4b, by means of a network controller NC of the processing unit 3.

More precisely, the processing unit 3 is equipped with an operating system ensuring management and making available all the software and hardware resources of the interaction device. These resources include, in particular, the input-output devices 2 and the software resources, which an application can access, for example, by means of an application programming interface (API) or through a function library. These resources can also be data stored in the memory MEM of the processing unit 3 and describing the state of the interaction device 1. These data or state variables can be very numerous, and, for example, include the charge level of the battery, the exact position of an actuator (for example, of the actuator controlling the position of the head of a humanoid robot), the state of connection with an auxiliary computing device 4a, etc.

The processing unit 3 is also equipped with applications making it possible to implement, for a specific purpose, the interaction device 1. Such applications rely on the functions of the operating system to take advantage of the available resources of the interaction device 1. Thus, an application will be able to call on a function of this system to access information provided by an input-output device 2, to activate such a device, or to be alerted by means of an event of the availability of such information.

An application for establishing social interaction with a user can be configured to have a plurality of interaction scripts, each interaction script defining a scenario of actions. The term “action” denotes any sequence of instructions executing on the processing unit 3 aimed at requesting one of the input-output devices 2. By way of illustration, such a script can correspond to a sequence of a quiz, which carries out the following actions:
display on the screen 2f of the interaction device 1, or state a predefined message in the loud speaker 2e of the interaction device 1, a question associated with four possible answers;
wait for a voice response from the user picked up by the microphone 2d of the device and analyze it to make it possible to determine the response chosen by this user;
display or utter a second predefined message depending on whether or not the response chosen by the user corresponds to the expected response.

A “social” application aimed at establishing an interaction between a user and the interaction device can be seen as a sequencing method consisting in sequentially executing interaction scripts chosen according to the interaction context, i.e., according to the information collected by the input-output devices 2 and the state of the interaction device 1 itself.

Natural Social Interaction

It was observed that to make an interaction between a human user and an interaction device 1 natural, during the execution of a social application, it is not sufficient for the interaction device 1 to base its actions on the simple occurrence of an external event caused by the user. It often appeared to be necessary to extract at least one characteristic that emerges from the interaction likely to be present between the user and the interaction device 1, so that the interaction device can adopt behaviors that appear natural, i.e., choosing an interaction script, which, when executed, is perceived as socially adapted by a user.

In the context of the present description, the characteristics that can emerge from the context of interaction are of particular interest. These characteristics are remarkable in that they result from the evolution over time of the interaction context, for a period of at least several seconds. Therefore, no interest is given to the first order, in one-off events, i.e., in external events occurring over a very short period of time such as, for example, snapping the fingers, activating a command button or even stating a keyword.

A whole variety of characteristics can be measured that are linked to an exchange of information and which are not associated with occasional external events. This can be, for example, the level of attention that the user pays to the exchange, i.e., his level of involvement in the exchange of information, or the level of interaction of the user with the interaction device 1, i.e., the intensity of the information exchange that takes place.

The measurement of user interaction and attention levels are characteristics that evolve throughout the interaction with the interaction device. They do not form one-off external events, even if the crossing of certain thresholds can, in itself, form an event occurring at a given moment. It was established that a measurement of at least one of these characteristics could be used to make social interaction more natural, and the present description proposes a device for measuring such a characteristic.

Measuring Device

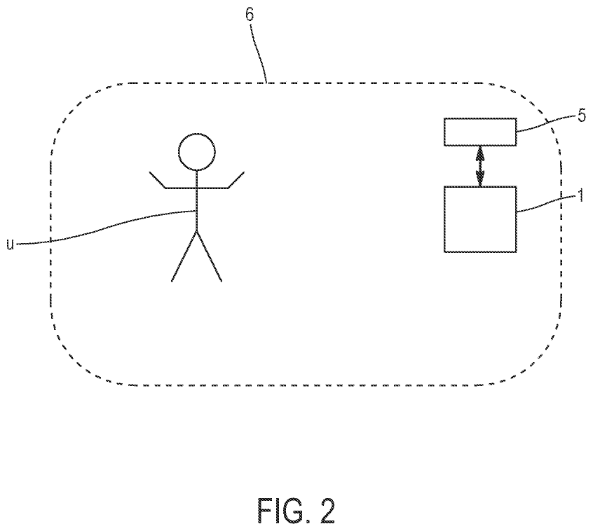

FIG. 2 is thus an example of a configuration allowing the occurrence of a social interaction between a user U and an interaction device 1. The user is likely to be present in an interaction zone 6. The interaction device 1 is connected to a measuring device 5 whose function is to establish a measurement of a characteristic of the exchange of information that can take place between the interaction device 1 and the user U. As it has been seen, this predefined characteristic can be an attention or interaction characteristic. The measuring device 5 has access to at least some of the information provided by the input-output devices 2 of the interaction device 1 and to its state variables. Alternatively, or in addition, the measuring device can be equipped with its own input devices, so as to itself collect certain data from the interaction context. The measuring device 5 has been shown here as a separate element from the interaction device 1, but it is also possible to envisage, while remaining within the scope of the present disclosure, that this measuring device be completely incorporated into the interaction device 1.

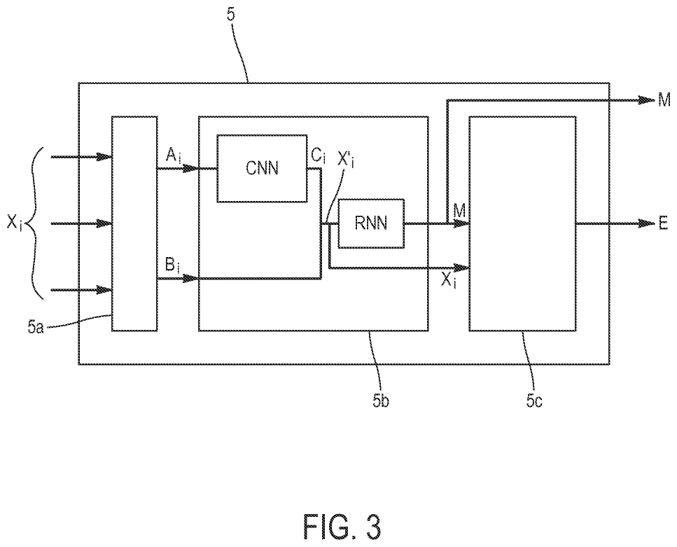

The measuring device 5, a particular example of implementation of which has been shown in FIG. 3, comprises an input interface 5a for receiving as input data from the interaction context and/or state variables of the interaction device. Xi will denote the data vector presented at time i at the input interface 5a. This data is provided repeatedly over time so that it can be put in the form of a temporal sequence {X1, Xn} of n data vectors.

The measuring device 5 also comprises, connected to the input interface 5a, a classification module 5b. Classification module 5b processes the temporal sequence of data {X1, Xn} to establish at output a measure M of the characteristic of the interaction, which one seeks to establish.

In order to be able to establish this measurement, the classification module 5b comprises a recurrent neuron network RNN, or any other architecture that can be configured by learning, to recognize the presence of the characteristic in the temporal sequence of data.

As is well known per se, such an architecture is configured during a learning phase. In the present case, the classification module 5b, and, in particular, the recurrent neural network RNN, was configured on the basis of temporal sequences of training data, i.e., temporal sequences of data associated with the information of presence or absence of the predetermined characteristic.

As stated previously, there is particular interest, in the context of this description, in measuring a characteristic capable of changing throughout the duration of the interaction. To take this temporal dimension into account, the classification module 5b is advantageously implemented by a LSTM-type (“Long Short Term Memory”) recurrent neuron network.

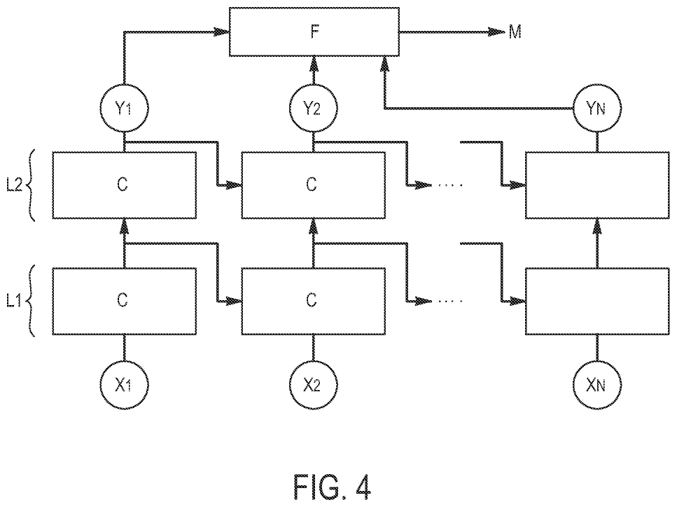

The general architecture of such a neural network is shown in FIG. 4, here in the form of an architecture having two layers L1, L2. Each layer L1, L2 consists of a row of n cells C successively chained to one another, an output of an upstream cell being connected to an input of a downstream cell. An output of each cell of a first layer L1 is also connected to an input of a cell of the same rank of the following layer L2. In addition to the two layers shown in the figure, additional hidden layers can be provided between the first layer L1 and the second layer L2. In general, it is possible to use an LSTM type network having a number h of layers. Each cell C comprises a memory for storing a state vector of the cell, and weighted gates to allow the state vector of the cell to evolve.

The temporal sequence of the input data {X1, Xn} is applied to the respective inputs of the n cells of the first layer. The LSTM network establishes a sequence {Y1, Yn} of output data. Each vector Yi of the output can be composed of the outputs of each layer of the LSTM-type network. A flattening function F can be applied to the sequence of the output vectors so as to combine the data together and form the measurement M.

The particular architecture of the recurrent neural network, i.e., the degree of recurrence (which defines the length of the input temporal sequence), the number of layers h forming the network is chosen according to the nature of the characteristic that are to be measured. A relatively high degree of recurrence will thus be chosen when the correlation between the determined characteristic and the interaction context incorporates a long period of time.

Certain information provided by the input-output devices 2 can be particularly rich, i.e., include a large volume of data. This is the case, for example, with images or sound signals provided, respectively, by the image sensor 2c or the microphone 2d. It is advantageous when this type of information is chosen to form an input of the measuring device 5, to provide a step of preprocessing these data so as to extract therefrom important characteristics Ci, and thus limit the quantity of data processed by the recurrent neural network RNN. These characteristics extracted from the image or the sound signal are then combined with the other data to form an input vector X′i, which will form the temporal sequence {X′1, X′n} applied to the recurrent neural network RNN. This processing can be performed by a convolutional neural network CNN. FIG. 3 is the architecture of a measuring device implementing such processing of a part Ai of the data Xi. The complementary part Bi, for example, the state variables of the interaction device, data Xi are recombined with the characteristics Ci to form the vector X′i, applied to the input of the recurrent neural network RNN.

The characteristic associated with social interaction that is measured can take an arbitrary number of states. For example, with regard to the attention characteristic, it may be the states of important attention, normal attention, weak attention and absence of attention. This number of states is predefined according to the characteristic measured and can be adapted according to the context of use of the measuring device 5. Advantageously, the measuring device 5 comprises an interpretation module 5c receiving as input the measurement M of the characteristic provided by the classification module 5b. Other information can be provided at the input of the interpretation module 5c, such as the data vector X′i provided at the input of the recurrent neural network RNN (as is the case in FIG. 3) or other information such as some forming the state variables of the interaction device 1 or those forming the interaction context. The interpretation module 5c processes this measurement M, and any additional information, to generate an event E at output showing the change of state of the characteristic. This event can be used by the interaction device 1, and, in particular, by the applications running on this device, for example, via its operating system. For this purpose, the interpretation module 5c can also be connected to the input interface 5a, so as to provide access to the data available in the interaction context. The interpretation module 5c can form a machine of which the states, and the transitions between the states are determined by the data of the interaction context, of the measurement M and/or of the other information provided to it as input.

A wide variety of information provided by the input-output devices 2 of the interaction device 1 can be provided, at the interface 5a of the measuring device 5. In a preferred embodiment, the interface 5a is connected to an input device formed by an image sensor 2c of the interaction zone 6 in which the user U is likely to be located. In this case, it is advantageous to process the images in order to extract the important characteristics therefrom, as has been explained previously. These characteristics can correspond to 500 to 10,000 data, which is much lower than the data corresponding to an image, even of modest resolution. The temporal sequence {X′i, X′n} of data provided to the recurrent neural network RNN then comprises a temporal sequence of the characteristics of images of the interaction zone. In addition, the input interface of the measuring device 5 can receive at least one of the state variables of the device. The combined processing of the image and/or sound temporal sequences, with at least one state variable of the interaction device is advantageous in that it makes it possible to clearly characterize the interaction that can take place with the user, and not only detect the occurrence of events directly and uniquely linked to the user when only images of the interaction zone are processed.

As has already been stated, the classification module 5b is configured during a learning phase from temporal sequences of learning data marked with the presence or absence of the characteristic that is to be measured. For this purpose, during (or prior to) the learning configuration of the measuring device 5, a user U and a conventional interaction device 1 are brought into interaction. Learning sequences of data are collected and labeled to mark the presence or absence of the characteristic that is to be measured. The temporal sequences of data may have been produced by at least one of the input-output devices of the interaction device 1 to which the measuring device is connected. The labeling step can be performed by an observer of the interaction, able to detect the presence or absence of the characteristic during the interaction, and therefore to label the temporal sequences of data collected. These tagged training temporal sequences are used to configure the classification module 5b so that it can identify in a new data temporal sequence the presence or degree of presence of the characteristic in question.

During the operation of the measuring device 5, a data temporal sequence, of the same type as that used for learning, is provided at the input of the classification module 5b via the input interface 5a, directly or indirectly connected to the input-output devices 2 of the interaction device 1. The classification module 5b supplies at output a measurement M representing a degree of presence of the characteristic in the sequence of data provided. This degree can be binary (0 absence of the characteristic or 1 presence of the characteristic) but also take a value in a range of real values, often between 0 and 1.

The measurements established by the measuring device 5 are communicated to the processing unit 3 and made available to the various applications, which can be executed on this processing unit 3 for them to take advantage of, according to the known computer mechanisms, which have been briefly described in the previous section of this description. It will be noted that the measuring device 5 can similarly be in hardware form (for example, in an integrated electronic component) or in software form. When it is in software form, it can be executed on a component of the processing unit 3 of the interaction device 1 (for example, the microprocessor uP) or on the auxiliary computing device 4a to which the processing unit 3 can be connected. This configuration can be particularly suitable when the complexity of the processing carried out by the measuring device requires access to capacities, which cannot be economically or technically integrated into the interaction device 1.

Using the Measuring Device

The measurement of the characteristic of the interaction provided by the measuring device 5 to the interaction device 1 can be used by an application running on this device to initiate, modify or interrupt an interaction script. When the measuring device 5 comprises an interpretation module 5c signaling, by events E, the changes of state of an interaction, these events E can be intercepted by applications running on the interaction device 1, to modify, depending on the nature of the event E, the progress of an interaction script during execution, or to initiate the execution of an interaction script chosen according to the nature of the event.

For example, an event E can testify to a change of state corresponding to a favorable moment to initiate a start of an exchange (a measurement of the attention characteristic crosses a threshold value, for example, upwards), and in this case a program, or the operating system itself, can initiate the execution of an initiation script of an exchange (speech synthesis of a prerecorded phrase: “Hello”).

Similarly, an event E can mark a change of state corresponding to the detection of the end of an exchange (the measurement of the interaction characteristic crosses downwards a floor value) and in this case a program engages the execution of a script to end the exchange (speech synthesis of a pre-recorded phrase: “Goodbye”).

Thus, at least one of the attention and interaction measurements (or any other predetermined characteristic of the interaction) can be used to detect a start and/or a suitable end of an exchange of information between the user U and the interaction device 1 and trigger or interrupt an interaction script at the most appropriate moment. The interaction device 1 can initiate the natural execution of an interaction initiation script without the user U needing to use a voice command, by keyword, or by activation of a command button, explicitly requiring the initiation of this interaction. Similarly, the interaction device 1 can initiate the execution of an exchange termination script.

### Example

In this example, the interaction device consists of a humanoid robot, such as, for example, described in document WO2009124951. The robot consists of articulated limbs, and a voice synthesis device, a plurality of microphones, a display touchscreen arranged on its trunk, and an image sensor whose optics are arranged in his head. Image resolution may be greater than 3 megapixels, and frame rate 5 frames per second or more. The sensor's optics are oriented to capture images of an interaction zone, near the robot, in which a user is likely to be present. The robot is also equipped with four sonars to measure the distance separating it from objects or people in its peripheral environment. The robot comprises low level control electronic boards respectively associated with the input-output devices that have just been listed, and, in particular, with the motors/sensors forming the joints of the robot.

A smart card, which can be arranged in the head or in the trunk of the robot, performs high-level missions and applications. It forms the processing unit 3 of this interaction device. The electronic card has a communication module making it possible to connect the robot to remote resources (script server, other robots, auxiliary computing device) and a memory making it possible to hold the robot's state variables (in particular, the position of each of the joints) and the other data provided by the input-output devices and the operating software for the basic functions of the robot or application software. The smart card is in communication via internal buses with the other electronic cards in order to transmit/receive the information and commands allowing the correct operation of the device. It houses, in particular, an operating system making it possible to coordinate all of the robot's resources, to control the concurrent execution of the operating software for the basic functions of the robot, and to house the application software on the smart card.

An application software (or application) of the robot can be a quiz, as was presented in a previous passage of the present description, during the execution of which the robot seeks to enter into interaction with a user. A basic function of the robot corresponds, for example, to continuously orienting its head so that it faces its interfacer (when the latter is moving). The interfacer's position can be determined from the images provided by the image sensor or from the sound information provided by the plurality of microphones. In operation, the application software or a plurality of such software runs concurrently with the operating software for the basic functions of the robot on the smart card.

In this example, the robot's smart card is connected to an auxiliary computing device to give it increased processing capacities. The auxiliary computing device is, in particular, designed to accommodate a device for measuring a predefined characteristic of an interaction likely to be present between the robot and a user.

In the present example, a device was chosen for measuring the level of attention that the user pays to the interaction with the robot and to present a second device for measuring the level of interaction that this user has with the robot. Of course, when no user is interacting with the robot, for example, when no user is present in the interaction zone, the measuring devices provide default values of these characteristics, for example, zero values.

The design of the measuring device includes a first phase during which the architecture of the classification module is determined. Here, an architecture specific to the attention measurement and to the interaction measurement is determined, thus defining two distinct measuring devices.

In both cases, however, the interaction devices conform to the structure shown in FIG. 3. The image data, provided by the image sensor, is fed to the convolutional neural network CNN. The processing carried out by this network makes it possible to extract images of around 2000 characteristics. These characteristics are combined with the orientation data of the robot head and the four distances provided by the sonars (which form the device state data) in order to form an input vector of the recurrent neural network.

The classification module of the attention measuring device has a degree of recurrence between 15 and 20, and between 100 and 150 layers. The classification module of the interaction measuring device has a degree of recurrence between 2 and 5, and between 10 and 30 layers.

The configuration of this device also includes a learning phase during which temporal sequences of training data are prepared (the same kind as those presented above), these sequences are marked by the presence or absence of the characteristics, and from which the interaction module is configured.

More specifically, during the learning phase, the robot is placed in a public area, the robot is started to run an application, for example, the quiz, so that users can interact freely for extended periods of time. The humanoid robot can call out to potential users using a text-to-speech invitation message, and the quiz application can be initiated by a user by pressing a button on the robot's touchscreen. During this free execution, at least part of the interaction data and of the state of the robot is continuously recorded by transmitting them, for example, to the auxiliary computing device where they are stored. In the particular example described, the images of the interaction zone provided by the robot's image sensor, the orientation of the robot's head during its interaction and the distances measured by the four sonars are transmitted to the auxiliary computing device and recorded. The scene in which the robot and the users are likely to interact can be filmed.

In a second step of the learning phase, an operator prepares all the data collected to prepare temporal sequences of training data. To do this, the operator carefully observes the film of the scene in which the robot and the users were likely to interact, to detect the presence or absence of the characteristics chosen, here the level of attention that a user pays to the interaction with the robot and the level of interaction he has with the robot. For each of these characteristics, it temporally marks the film depending on whether this characteristic is present or not. And it uses this information to also temporally mark the data provided by the robot's image sensor, the orientation of the robot head, the four distances provided by the sonars and constitute temporal sequences of training data marked with the presence or absence of characteristics.

In a next step of the learning phase, the temporal sequences of marked training data are used to configure the recurrent RNN and convolutional neural networks CNN forming the classification modules of each of the devices. To do this, the classification modules of each measuring device, the images provided by the sensor, the orientation data of the robot head and the distances provided by the four sonars are presented successively at the input of the classification modules. The information on the presence or absence of attention and interaction is presented at the output of the modules, respectively. The parameters of each of the cells of the two neural networks forming each classification module are adapted to make the calculated output converge toward the output presented. For this, an algorithm can be applied based on the back propagation of the gradient.

In the measuring devices in this example, an interpretation module has also been provided. They are here configured very simply to generate, in the attention measuring device, an event of gain or loss of attention depending on whether the measurement of the level of attention provided by the classification module crosses upward or downward a specific threshold. Similarly, the interaction measuring device generates an interaction or absence of interaction event depending on whether the measurement of the level of interaction provided by the classification module crosses upwards or downwards a predefined threshold.

Once the classification module of each measuring device has been configured, that measuring device can be operated by the humanoid robot to make its interactions more instinctive. In one example chosen, the two measuring, attention and interaction devices are implemented in the auxiliary computing device, connected to the robot's smart card. Provision could also be made to integrate the measuring devices thus prepared in the robot itself, such as software implemented on the electronic card forming the processing unit, or as an additional electronic card in communication with this processing unit.

In any case, the applications running on the robot can take advantage of the information provided by these attention and interaction measuring devices. This information can be used as provided, respectively, by the classification modules, for example, in the form of a real numerical value between 0 and 1. The values provided by this module can be integrated into the device state data, and therefore made accessible to any software running on the robot. This information can also be used by the applications by intercepting the events generated by the interpretation modules.

In operation, the measuring devices associated with the humanoid robot receive at their input interfaces the temporal sequences of data formed from the images provided by the image sensor, by the orientation of the head, by the sonar distance measurements. These sequences are respectively provided to the classification module of each device, which continuously determines a measurement of attention and interaction. These measurements are also provided to the interpretation modules, which generate events, transmitted to the processing unit, according to the thresholds crossed during the evolution of the measurements.

Continuing the quiz application taken as an example, when such an application is configured to take advantage of the data provided by the measuring device, it is no longer necessary for a user of a humanoid robot to press a button on the robot touchscreen to start the application. At least one of the robot's measuring devices provides the application with the event triggering its execution. Similarly, the measuring devices provide the application with the event triggering its interruption, for example, if the user's attention and/or his interaction drops.

As will be readily understood, the present disclosure is not limited to the described embodiments, and it is possible to add variants thereto without departing from the scope of the invention as defined by the claims.

1. A device for measuring a predefined characteristic of an interaction likely to be present between an interaction device and a user, comprising: an input interface connected to the interaction device and to an image sensor or sound sensor coming from an interaction zone in which the user is likely to be located and thus receive data representative of the interaction, and a classification module connected to the input interface processing:
a temporal sequence of the image or sound data of the interaction zone; and
a temporal sequence of at least one state variable of the device;
in order to establish at output a measurement of the predefined characteristic, the classification module having been configured on the basis of temporal sequences of training data marked with the presence or absence of the characteristic.

2. The device of claim 1, wherein the predefined characteristic can take a predetermined number of states and the device comprises an interpretation module receiving as input the measurement of the predefined characteristic and processing the measurement to generate at output an event marking the change of state of the characteristic.

3. The device of claim 2, wherein the classification module comprises a recurrent neural network.

4. The device of claim 3, wherein the interpretation module is connected to the input interface.

5. The device of claim 4, wherein the predefined characteristic is a level of attention of the user.

6. The device of claim 5, wherein the predefined characteristic is a level of interaction of the user with the interaction device.

7. A method for measuring a predefined characteristic of an interaction likely to be present between an interaction device and a user, the measuring method comprising the following steps:
receiving at least one state variable of the device and image or sound data representative of the interaction via an image sensor or sound sensor originating from an interaction zone in which the user is likely to be located;
providing a temporal sequence of the state variable and image or sound data to a classification module configured from temporal sequences of training data marked by the presence or absence of the characteristic; and
processing the temporal sequence by the classification module to establish a measurement of the predefined characteristic.

8. The method of claim 7, wherein the predefined characteristic can take a determined number of states, the method comprising:
providing the measurement of the predefined characteristic to an interpretation module; and
processing the measurement by the interpretation module to generate an event marking the change of state of the characteristic.

9. The method of claim 7, wherein the processing is carried out on a computing device separate from the interaction device.

10. An interaction device comprising a measuring device according to claim 1.

11. A method comprising using a measuring device according to claim 1 for detecting a start and/or an end of the interaction between the user and the interaction device.

12. The device of claim 1, wherein the classification module comprises a recurrent neural network.

13. The device of claim 2, wherein the interpretation module is connected to the input interface.

14. The device of claim 1, wherein the predefined characteristic is a level of attention of the user.

15. The device of claim 1, wherein the predefined characteristic is a level of interaction of the user with the interaction device.
